(19) United States
(12) Patent Application Publication
(10) Pub. No.: US 2024/0114830 A1
(43) Pub. Date: Apr. 11, 2024

(54) Seedbed Preparation Method and Mechanism

(71) Applicant: Tribine Industries LLC, Logansport, IN (US)

(72) Inventors: Ben N. Dillon, Logansport, IN (US); Dillon M. Thompson, Burdett (UA)

(73) Assignee: Tribine Industries LLC, Logansport, IN (US)

(21) Appl. No.: 18/480,777

(22) Filed: Oct. 4, 2023

Related U.S. Application Data
(63) Continuation-in-part of application No. 17/938,156, filed on Oct. 5, 2022.
(60) Provisional application No. 63/519,575, filed on Aug. 15, 2023.

(51) Int. Cl. A01D 41/04; A01B 69/08; A01C 5/06; A01C 7/06; A01C 7/08

(52) U.S. Cl. CPC A01D 41/04; A01B 69/006; A01C 5/062; A01C 5/066; A01C 7/06; A01C 7/08; A01M 21/043

(57) ABSTRACT

A farm machine includes a towing vehicle carrying at its front a pair of laterally extending and foldable arms supported by caster wheels and extending laterally away from the towing vehicle. Each of the longitudinally extending foldable arms carry a series of planting assemblies that include a cutting assembly for chopping crop residue, a trench forming assembly for forming seed trenches, a seed sowing assembly for sowing seed in the trench, and a packer assembly for tamping down the seeded trench. A steerable towed vehicle carries seed and fertilizer and is towed by the towing vehicle. A laterally extending arm supports additional planting assemblies that extend substantially the width of the towing vehicle.

### CROSS-REFERENCE TO RELATED APPLICATIONS

This application claims benefit of provisional 63/519,575 filed Aug. 15, 2023, and is a continuation-in-part of application Ser. No. 17/938,156 filed on Oct. 5, 2022.

### STATEMENT REGARDING FEDERALLY SPONSORED RESEARCH AND DEVELOPMENT

Not applicable.

### THE NAMES OF THE PARTIES TO A JOINT RESEARCH AGREEMENT

Not applicable.

### REFERENCE TO A “SEQUENCE LISTING,” A TABLE, OR A COMPUTER PROGRAM

Not applicable.

### STATEMENT REGARDING PRIOR DISCLOSURES BY THE INVENTOR OR A JOINT INVENTOR

Not applicable.

### BACKGROUND OF THE INVENTION

The present disclosure relates to farming in general and more particularly to an improved tillage method and equipment.

It is desirable to facilitate carbon sequestration and increase the organic matter in the soil by reducing tillage and the number of trips across the field by tractors and implements to grow and harvest a crop. Traditionally, up to 5 passes are made across a field in order to chop up stalks from a prior year or a cover crop, for example, plant seed, fertilize the seed, nitrogenate the soil, and the like.

Each time a tractor or harvester traverses a field, the wheels/tracks of these heavy unit compact the soil, which is detrimental for planting crops. This problem is addressed in commonly-owned application Ser. No. 17/938,156, cited above, which discloses a seedbed preparation and planting machine that includes a cutting assembly including powered forward cutting blades for chopping crop residue. A cutting disc assembly follows the cutting assembly effective for forming a seedbed trench at a seed planting depth. A seed assembly follows the cutting disc assembly including a seed hopper and a seed tube located to drop seed into the seedbed trench. A packer assembly tamps down seed in the seedbed trench for covering seed therein. This machine is effective whether a cover crop or harvested reside (e.g., corn stalks) remains in the field. While these units are a significant step forward in farming, its integration into conventional farming equipment still is needed.

It is to this problem that the present invention is addressed.

### BRIEF SUMMARY OF THE INVENTION

This invention has elements that are ground driven by engaging the soil passing under the machine. It also has elements that are powered by a mobile source moving with the machine. This provides the ability to engage the soil and residue at a speed directly proportional to the velocity over the ground of the machine and simultaneously engage the soil and residue at speeds different than ground speed of the machine.

This invention is directed towards these two objectives. It prepares the seedbed for planting crops during the same process and trip across the field that is planting the seeds in the ground to germinate and grow. It also effectively deals with heavy residue left on the ground from the previously harvested crop, such as corn, by clearing residue from a narrow path for the new crop to be planted. The residue is both chopped into smaller pieces and pushed aside from the new seedbed. As only one example the new seedbed may be in the range of, say, for example, 100 millimeters wide.

In an embodiment, a single thin ground powered cutting disc oriented to cut longitudinally is located centrally on the same shaft as two adjacent mechanically powered rotating cutting blades that are shaped to fluff the soil that will be the seedbed and chop residue still in its path while also moving it aside. The cutting disc ensures that any residue disposed generally across the projected path of the new seedbed is cut at least once before it is encountered by the chopping blades. The cutting disc penetrates the soil to a depth greater than the chopping blades and the intended depth of the crop seed. The chopping blades penetrate the soil to a depth greater than the intended depth of the seed placement. The operating depth of the seedbed preparation mechanism is independent of the operating depth in the soil of the seed placement mechanism.

The rear module of the articulated combine is fitted with tanks, seed blowers, and transfer pump for fertilizer and is mounted on the existing design frame, axle, and steering system; but it is a separate, distinct module. The planting module and the harvesting module must be disconnected from the common front module power unit and switched for planting row crops or harvesting. The harvesting configuration can have an attachment to the header to seed non row crops, such as, a cover crop like rye or canola Such rear module can be the rear unit of an articulated vehicle, such as a harvester.

Towed behind the tank rear assembly by a 3-point towing and hydraulic powered lifting hitch that engages a rear tool bar with 6 row tiller and planting assemblies mounted on the tool bar which are also hydraulically powered. Thus, there are 6 more tiller-planter assemblies not mounted on the front mounting folding tool bar. This split arrangement of tiller/planting assemblies allows front folding of the forward assemblies to be folded inwardly and the tire tracks tilled by the rear mounted row tiller/planters. The machine, therefore, plants 16 contiguous rows during each pass across the field in the unfolded position. Of course, the number of tiller/planter assemblies on the forward assembly and the number behind the tank could be in different number than those set forth herein and in the drawings.

Another aspect disclosed herein is an improved tractor having a pair of laterally extending arms having ends and forwardly carried by the improved tractor, and a pair of caster wheels located about the laterally extending arm ends, wherein the pair of laterally extending arms foldable inwardly for turning of the tractor. This tractor may be a harvester. Yet another aspect is an improved tractor having a forward wheeled module for planting seed in a field, and a rear wheeled module located behind the forward module and carrying tanks for seed, fertilizer, and nitrogen. This tractor also may be a harvester.

### BRIEF DESCRIPTION OF THE SEVERAL VIEWS OF THE DRAWINGS

For a fuller understanding of the nature and advantages of the present method and process, reference should be had to the following detailed description taken in connection with the accompanying drawings, in which:

FIG. 1 is an isometric view of the disclosed machine that includes a folding front tiller/planter bar assembly, an articulated combine with a rear fertilizer/planter module, and a towed tiller/planter bar assembly;

FIG. 2 is an isometric view of the disclosed machine of FIG. 1 with the forward pair of tiller/planter bar assemblies folded inwardly to facilitate a shorter turning radius;

FIG. 3 is an overhead view of the disclosed machine of FIG. 1 operating in a field;

FIG. 4 is an overhead view of the machine shown in FIG. 2;

FIG. 5 is a side view of the machine of FIG. 4;

FIG. 6 is a side view of the machine shown in FIG. 1; and

FIG. 7 is an isometric view of the rear tank module towing a fertilizer/planter module via a 3-point towing hitch;

FIG. 8 is a side view of the module shown in FIG. 7;

FIG. 9 is a front view of the front of the rear tank module;

FIG. 10 is a side of one embodiment of the tiller planter assemblies;

FIG. 11 is a side view of the tiller/planter assembly shown in FIG. 10;

FIG. 12 is a side view of another tiller/planter assembly with the forward tiller assembly at ground level;

FIG. 13 is the tiller/planter assembly of FIG. 12 with the forward tiller assembly pushed into the ground for tilling the field and the furrow assembly also pushed into the ground for forming a seed furrow;

FIG. 14 is that view of FIG. 13, except that the furrow assembly is moved upwardly to ground level;

FIG. 15 is that view of FIG. 14 with the forward tiller assembly lifted above ground level; and

FIG. 16 is another embodiment of the tiller/planter assembly with the tiller assembly spaced-apart from the furrow/planting assembly.

The drawings will be described in more detail below.

### DETAILED DESCRIPTION OF THE INVENTION

The disclosed machine has the ability to chop field residue and push the chopped material to the side. The rear module contains seed, fertilizer, and/or nitrogen on board. Finally, trailing the rear module is a second set of elements to chop field residue across the width of the machine which area is left undisturbed by the front folding assemblies. Thus, the machine prepares the seedbed for planting crops during the same process and trip across the field that it is planting the seeds in the ground to germinate and grow. It also effectively deals with heavy residue left on the ground from the previously harvested crop, such as corn, by clearing residue from a narrow path for the new crop to be planted. The residue is both chopped into smaller pieces and pushed aside from the new seedbed. As only one example, the new seedbed may be in the range of, say, for example, 100 millimeters wide. Moreover, fertilizer is applied at the time of planting seed. All of these activities are performed by a machine that is field maneuverable and able to be backed up.

Importantly, the disclosed integrated farming machine can be backed up and it can be turned in the required radius in the field. Since today's farming equipment require up to 5 towed units, the turning radius can be preclusive in many fields. Moreover, these “trains” of farming equipment cannot be backed up. The present invention solves the problems inherent in such farm equipment trains.

In an embodiment, a single thin ground powered cutting disc oriented to cut longitudinally is located centrally on the same shaft as two adjacent mechanically powered rotating cutting blades that are shaped to fluff the soil that will be the seedbed and chop residue still in its path while also moving it aside. The cutting disc ensures that any residue disposed generally across the projected path of the new seedbed is cut at least once before it is encountered by the chopping blades. The cutting disc penetrates the soil to a depth greater than the chopping blades and the intended depth of the crop seed. The chopping blades penetrate the soil to a depth greater than the intended depth of the seed placement. The operating depth of the seedbed preparation mechanism is independent of the operating depth in the soil of the seed placement mechanism.

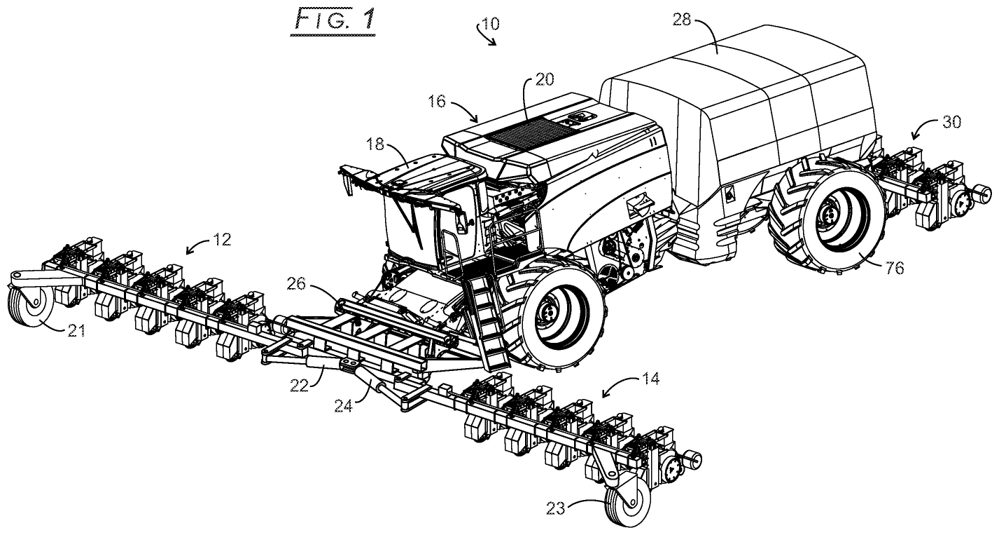

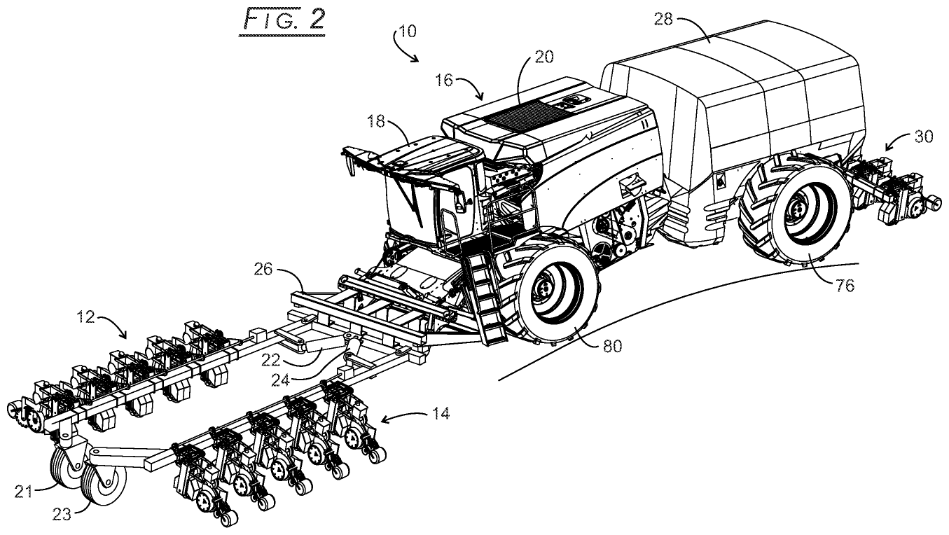

Referring initially to FIGS. 1 and 2, a seedbed preparation machine, 10, has the ability to cut up crop residue, such as, for example, corn stalks, and to plant a new crop, such as, for example, a cover crop. In agriculture, cover crops are plants that are planted to cover the soil rather than for the purpose of being harvested. Cover crops manage soil erosion, soil fertility, soil quality, water, weeds, pests, diseases, biodiversity, and wildlife in an agroecosystem—an ecological system managed and shaped by humans. Cover crops may be an off-season crop planted after harvesting a cash crop. Machine 10 includes forward caster-wheeled cutting blade assemblies, 12 and 14, located laterally away from a forward bogey, 16, that includes an operator cab, 18, and a power unit, 20. A pair of cylinder assemblies, 22 and 24, effect folding forwardly and inwardly of wheeled cutting blade assemblies 12 and 14. A forward structural framework, 26, is carried by forward bogey 16, cylinder assemblies 22 and 24, and cutting blade assemblies 22 and 24. Further details on the cutting blade assemblies can be found in commonly-owned U.S. Ser. No. 17/938,156, cited above.

Caster wheels, 21 and 23, support cutting blade assemblies 12 and 14, respectively, and permit them to be folded inwardly such that the machine can driven forward and backed up while in the folded state, as shown in FIG. 2. Moreover, steering of machine 10 is accomplished by rear wheels 76 and 78 of rear module 28 to further tighten the turning radius of machine 10. FIG. 2 shows machine 10 in a turning mode. Further, in the configuration illustrated in FIG. 2, machine 10 can be backed up, which is of distinct benefit to the machine operator.

FIG. 3 shows machine 10 in a field with cutting blade assemblies 12, 14, and 30 performing the various functions of chopping field residue, forming furrows, planting seed in the furrows, and adding fertilizer and/or nitrogen into the seeded furrows followed by covering the furrows. Note that the arrangement of wheeled cutting blade assemblies 12, 14, and 30 are strategically placed such that the planted furrows straddle the wheel ruts created by wheels 76, 78, 80, and 82 so that wheel compaction is not an issue.

The planting vehicle efficiently performs multiple operations that are presently being done by several different implements being pulled across the field by a large tractor as follows:
1. deep tillage after harvest to remove combine, grain cart, and tractor compaction tracks and ruts;

2. applying Nitrogen in the form of anhydrous ammonia or liquid 28% with a toolbar fertilizer applicator or a strip tiller in all upcoming corn planted fields; and
3 preparing the seedbed for planting with a field cultivator except in those parts of the country where an existing No-Till planter with a ground powered row opener can do an acceptable job; thus, eliminating the capital cost of the big tractor and implements, plus labor and fuel to complete these operations has a huge impact on farmer profitability.

The disclosed integrated vehicle that is towed has the following functions:
1. a seedbed preparation mechansism-6-inch-wide powered tiller;
2. a row planter of discreet seeds; and
3. fertilizer placement in correct proximity to the seeds.

Machine 10 also has a rear bogey, 28, fitted with tanks, seed blowers, and a transfer pump for fertilizer is mounted on the existing design frame, axle, and steering system; but it is a separate, distinct module. Finally, a rear cutting blade assembly, 30, is pulled by the unit and is identical in operation as are cutting blade assemblies 12 and 14. Assembly 30 performs its operation on the field represented by the width of the machine, which width is not covered by forward cutting blade assemblies 22 and 24.

Carrying a truckload of fertilizer and seed in an integrated rear part of the vehicle that has powered wheels that work in concert with the front module wheels for both power and bidirectional steering and is not towed represents an improvement in the art. The machine further incorporates means for transferring the seed and fertilizer from the storage tanks to the row placement units in the required amounts.

Rear cutting assembly 30 is towed by an operator controlled 3-point hitch, 29 (see FIG. 5, for example), on the rear capable of lifting several thousand pounds in a controlled manner such as compaction mitigation accessories or a seeder. Optionally, the machine could be fitted with a notched tire assembly as is disclosed in commonly-owned U.S. Ser. No. 18/811,630 filed Jul. 11, 2022.

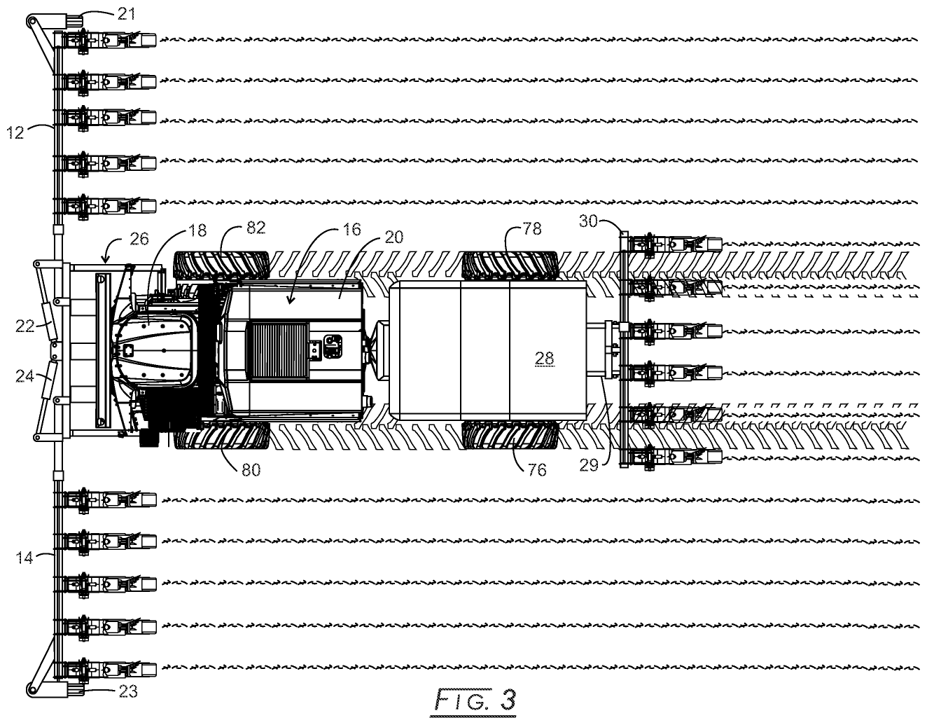

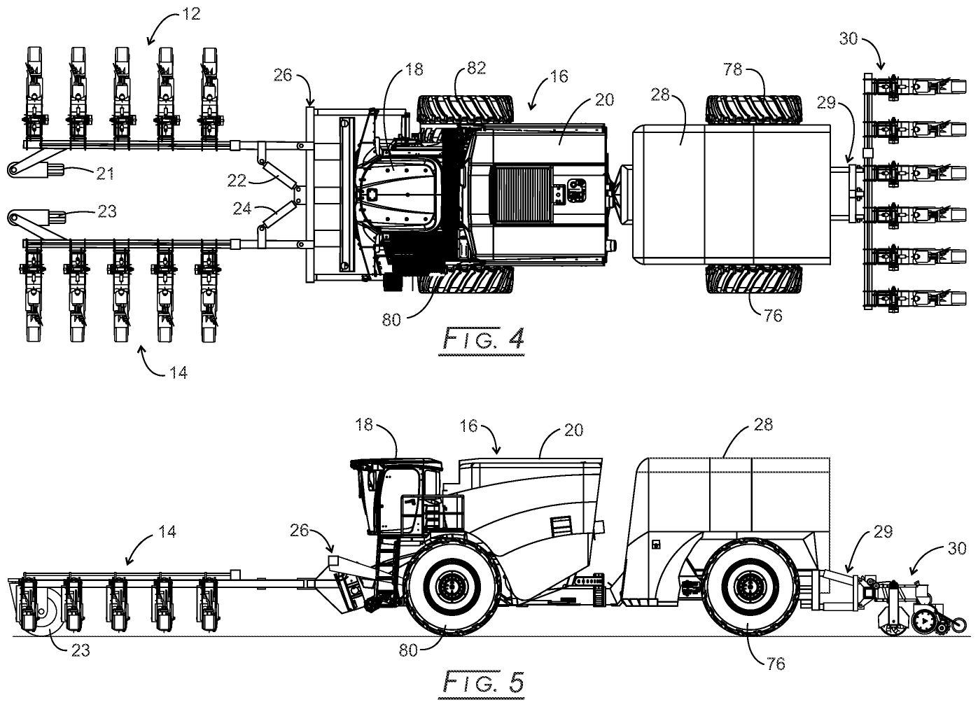

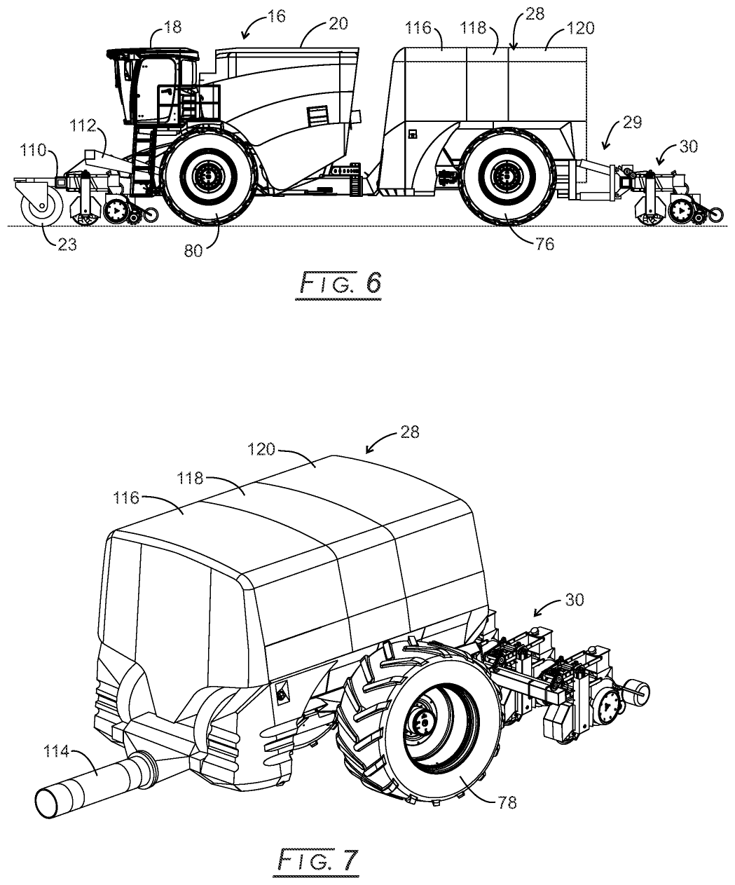

Referring now to FIGS. 4 and 5, it will be observed that machine 10, as shown, clears and plants 16 seeded furrows. Of course that number could be higher or lower depending upon needs. It also is possible to directly attach the forward cutting blade assemblies, such as cutting blade assembly 110 directly to a feedhouse assembly, 112, of forward bogey 16 when that bogey is from a combine. For turning, of course, the feedhouse assembly would lift the forward cutting blade assemblies up for turning of the machine.

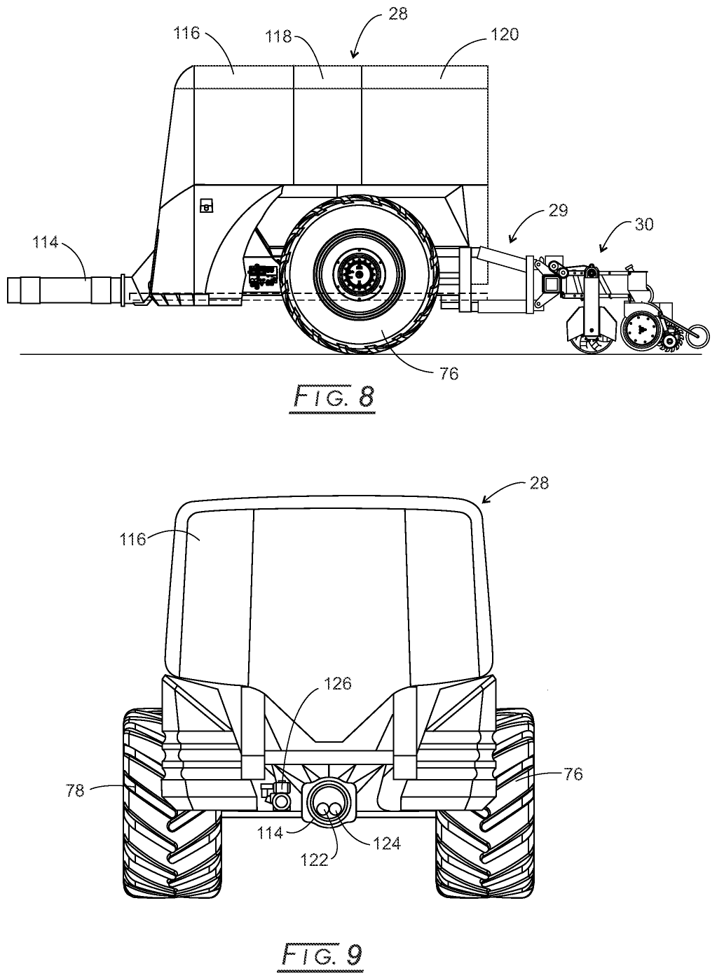

Rear bogey 28 is shown in FIGS. 7-9 towing cutting blade assembly 30 using 3-point assembly 29. A tube, 114, connects front bogey 16 to rear bogey 28 and carries lines for transferring seed, fertilizer, and nitrogen to forward cutting blade assemblies 12 and 14. Rear module/bogey 28 is seen to have 3 distinct units. A forward unit, 116, carries seed which is blown using a fan located beneath rear bogey 28. Liquid lines, 122 and 124, are located with tube 114 for passing liquid fertilizer and nitrogen (anhydrous nitrogen) to the forward cutting blade assemblies using a pump, 126, also located beneath unit 28. Unit 118 carries fertilizer while unit 120 carries the nitrogen. Of course, the onboard units of rear bogey 28 could be in a different order and/or could carry other materials than those discussed herein.

The cutting blade assemblies are disclosed in detail in U.S. Ser. No. 17/938,156 cited above. While each cutting blade may be powered by its own power source, shown is a rotating bar that rotates within bearing assemblies for the cutting wheels. The rotating bar drives a chain assembly including a pair of sprockets which transfer motion to an axle that causes rotation of the cutting blade and a ground powered disc that carries the sprockets. Spring assemblies provide downward force for the cutting assemblies. The spring assemblies in turn are attached to pivot assemblies, which pivot assemblies are carried by chain assembly. The cutting assembly further includes a hood to shield dirt and debris tossed up by the cutting blade. All other cutting assemblies are powered in this manner.

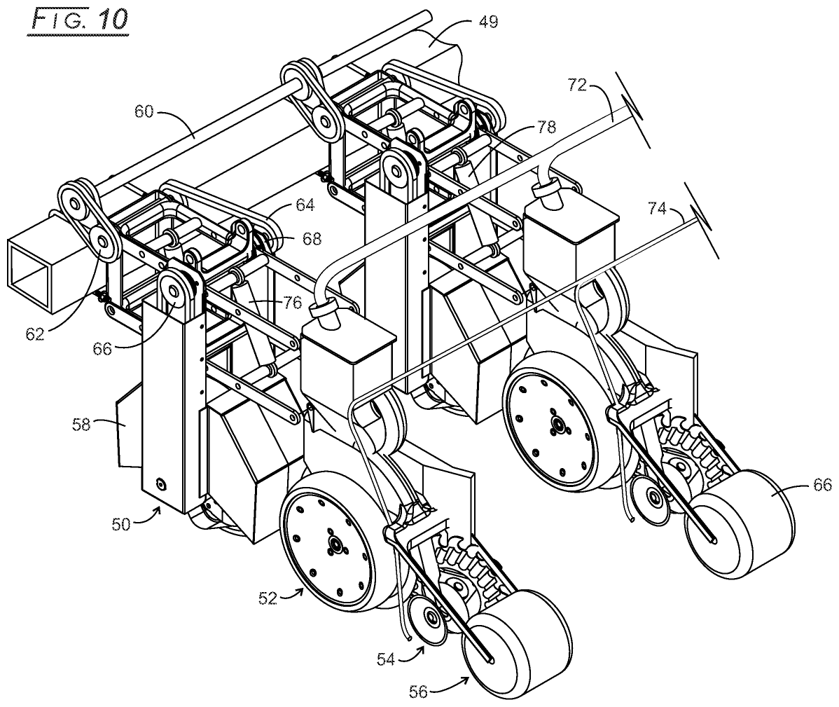

Referring initially to FIGS. 10 and 11, a pair of cutting assemblies are shown in detail. An elongate structural bar, 49, typically made of steel, carries the various components that form these assemblies. These assemblies generally are a forward chopping assembly, 50, a trenching/seeding assembly 52, a packer assembly, 54, and a roller assembly, 56.

Forward chopping assembly 50 is surmounted by a hood, 58, and consists primarily of a plurality of blades for chopping up any vegetation present in the field be that a cover crop, weeds, or crop residue. A series of pulley assemblies can be independently powered or powered in gang, such as by a rotating bar, 60, that rotates a first pulley assembly, 62, that powers a second pulley assembly, 64, that in turn powers vertical pulley assemblies, 66 and 68. Two such vertical pulley assemblies are required inasmuch as a pair of rotating blade assemblies are housed beneath hood 58. Again, such chain of pulley assemblies are interconnected by rotating bars in the manner of rotating bar 60.

Rotating disc assembly 50 is seen in FIG. 11 to have a series of rotating blades typified by a rotating blade, 70, that assembly is lowered into the ground (described in further detail below) for the rotating blades to chop up any vegetation encountered. Following that is rotating disc assembly 52 that forms a farrow in the vegetative-free ground, again by being lowered into the soil (described in further detail below).

Jumping back to FIG. 10, seed is blown from seed tank 16 aboard rear bogey 28 through a line, 72, and into the created furrow. The seed is fertilized via a line, 74, pumped from rear bogey 28. Additional such lines can convey nitrogen, weed killer, and/or any other desired substance for the planted seed using additional lines fed from rear bogey 28. For that matter, rear bogey 28 could carry more than 3 tanks if any additional substance is required to be fed to the seed. Packer assembly 54 follows that covers the seeded farrow with adjacent soil. Finally, roller assembly 56 smooths the soil.

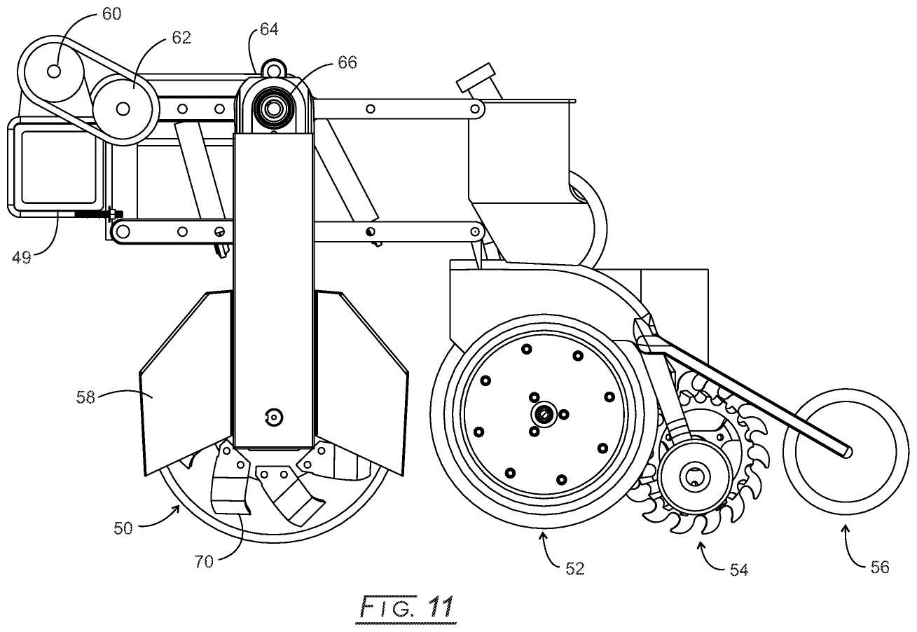

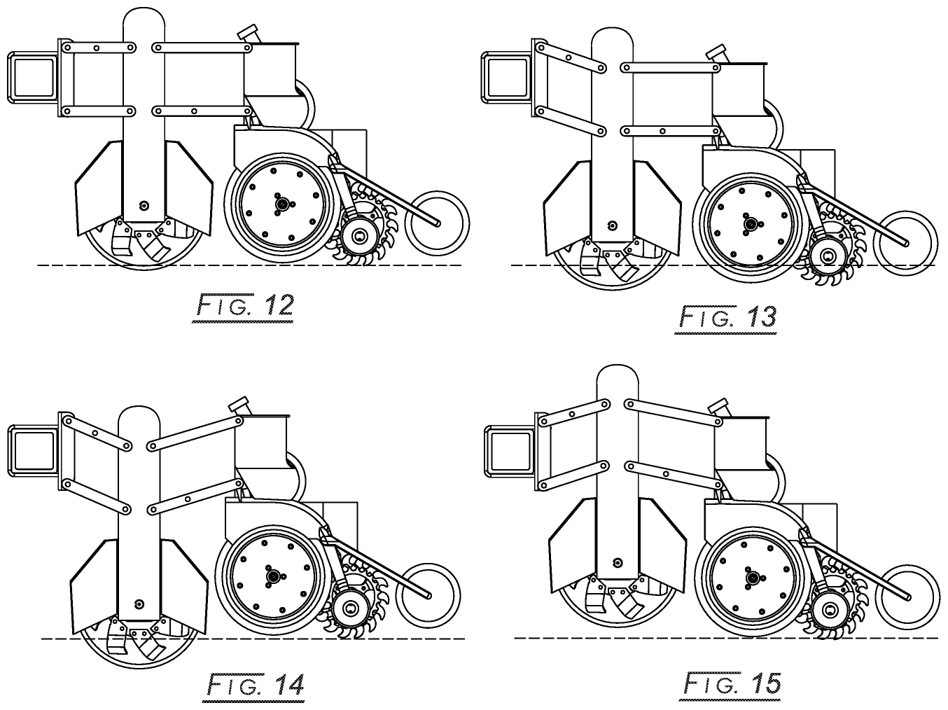

The sequence of events described above is seen in FIGS. 12-15. In FIG. 12, the various elements of the cutter assemblies are shown traversing the soil at ground level. In order to initiate seed planting, cutter assembly 50, rotating disc assembly 52, and packer assembly 54 are pushed down into the soil typically using a piston assembly, 76 and 78 (see FIG. 10), for cutter assembly 50 and other not shown piston assemblies for disc assembly 52 and packer assembly 54. In FIG. 14, disc assembly 52 and packer assembly 54 have been raised back to ground level while cutter assembly 50 remains below ground level. Finally, FIG. 15 illustrates cutter assembly 50 being raised above ground level, such as, for example, for machine 10 to be turned or driven along a road or highway. Various structural link arm assemblies are attached the described assemblies permitting the raising and lowering of the assemblies as described herein.

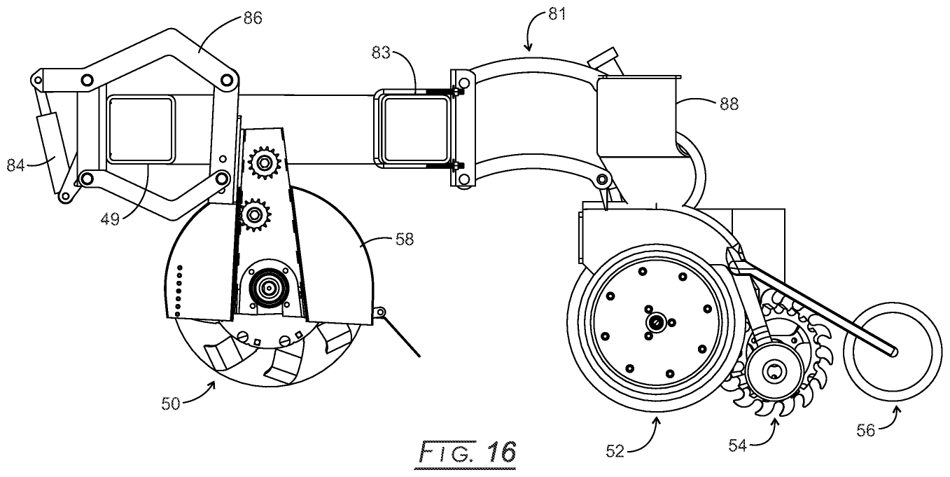

Referring now to FIG. 16, an alternative embodiment for the cutter assemblies is shown. In particular, a parallel link arm assembly, 81, is interposed between cutter assembly 50 and disc assembly 52. A pair of structural beams 50 and 83 carry all of the assemblies. A piston, 84, is connected to a scissors assembly, 86, for raising and lowing cutting assembly 50. A seed hopper, 88, is placed above disc assembly 52.

While the apparatus, system, and method have been described with reference to various embodiments, those skilled in the art will understand that various changes may be made and equivalents may be substituted for elements thereof without departing from the scope and essence of the disclosure. In addition, many modifications may be made to adapt a particular situation or material in accordance with the teachings of the disclosure without departing from the essential scope thereof. Therefore, it is intended that the disclosure not be limited to the particular embodiments disclosed, but that the disclosure will include all embodiments falling within the scope of the appended claims. In this application all units are in the metric system and all amounts and percentages are by weight, unless otherwise expressly indicated. Also, all citations referred herein are expressly incorporated herein by reference.

1. A farm machine, which comprises:
(a) a towing vehicle carrying at its front a pair of laterally extending and foldable arms supported by caster wheels and extending laterally away from the towing vehicle, each longitudinally extending foldable arm carrying a series of planting assemblies comprising:
(i) a cutting assembly for chopping crop residue;
(ii) a trench forming assembly for forming seed trenches;
(iii) a seed sowing assembly for sowing seed in the trench; and
(iv) a packer assembly for tamping down the seeded trench;
(b) a steerable towed vehicle carrying seed and fertilizer and being towed by the towing vehicle; and
(c) a laterally extending arm supporting additional of the planting assemblies and extending substantially the width of the towing vehicle.

2. The farm machine of claim 1, wherein the seedbed preparation and planting assemblies are powered independently of the towing vehicle.

3. The farm machine of claim 1, wherein the towing vehicle is support by a pair of wheels and the steerable towed vehicle is supported by a pair of rear steerable wheels.

4. The farm machine of claim 1, wherein the towing vehicle longitudinally extending foldable arm carrying the series of planting assemblies are folded inwardly when the pair of rear steerable wheels of the steerable towed vehicle are turned for turning the farm machine.

5. The farm machine of claim 1, wherein the towed vehicle also carries a supply of weed killer for adding to the seeded trench.

6. A single pass method for clearing a field planted with a crop and planting fertilized seed, which comprises the steps of:
(a) driving over the field a farm machine equipped with a pair of forward longitudinally extending foldable arm carrying a series of clearing and planting assemblies;
(b) supplying seed and fertilizer from a steerable towed vehicle being towed by the farm machine to the clearing and planting assemblies seed; and
(c) supplying seed and fertilizer from the steerable towed vehicle to a rear laterally extending arm supporting additional clearing and planting assemblies which extend substantially the width of the steerable towed vehicle.

7. The single pass method claim 6, additionally comprising the step of powering the seedbed preparation and planting assemblies independently of the towing vehicle.

8. The single pass method claim 6, additionally comprising the step of providing a pair of forward wheels to support the towing vehicle and providing a pair of steerable rearward wheels to support the towed vehicle.

9. The single pass method of claim 8, additionally comprising turning the farm machine by folding inwardly the pair of forward longitudinally extending foldable arm carrying a series of clearing and planting assemblies and turning the pair of rearward wheels.

10. The single pass method of claim 6, additionally comprising supplying weed killer from the towed vehicle.

11. An improved tractor, wherein the improvement comprising:
a pair of laterally extending arms having ends and forwardly carried by the improved tractor,
a pair of caster wheels located about the laterally extending arm ends, and
the pair of laterally extending arms foldable inwardly for turning of the harvester.

12. The improved tractor of claim 11, wherein the harvester has a forward wheeled bogey for a driver and a wheeled rear bogey therebehind.

13. The improved tractor of claim 12, wherein the forward bogey plants seed in furrows in a field and the planted seeds are fertilized and nitrogenated by a forward assembly carried by the forward bogey, and
the rear bogey carries seed, fertilizer, and nitrogen for feeding the forward bogey forward assembly.

14. The improved tractor of claim 12, which is steered by the wheeled rear bogey.

15. The improved tractor of claim 12, which is a harvester.

16. An improved tractor comprising:
a forward wheeled module for planting seed in a field, and
a rear wheeled module located behind the forward module and carrying tanks for seed, fertilizer, and nitrogen.

17. The improved tractor of claim 16, which is steered by the rear wheeled module.

18. The improved harvester of claim 16, wherein the tractor comprises a harvester.
